(19) United States
(12) Patent Application Publication
(10) Pub. No.: US 2012/0085314 A1
(43) Pub. Date: Apr. 12, 2012

(54) USE OF PRESSURIZED FUELS IN AN INTERNAL COMBUSTION ENGINE

(76) Inventor: James M. Cleeves, Redwood City, CA (US)

(21) Appl. No.: 13/270,176

(22) Filed: Oct. 10, 2011

Related U.S. Application Data
(60) Provisional application No. 61/391,487, filed on Oct. 8, 2010.
(60) Provisional application No. 61/501,654, filed on Jun. 27, 2011.

(30) Foreign Application Priority Data
Oct. 8, 2011 (US) PCT/US2011/055501

(51) Int. Cl. F02D 41/30

(52) U.S. Cl. 123/294

(57) ABSTRACT

An amount of inlet air can be delivered to a combustion volume of an internal combustion engine via an air inlet port, and delivery of an amount of a fuel from a compressed fuel reservoir to the combustion volume can be controlled via a pressurized fuel inlet port positioned to the deliver the amount of the fuel directly into the combustion volume separately from the air inlet port. The amount of the fuel can be controlled relative to the amount of the inlet air to create an air-fuel mixture within the combustion volume having a target air/fuel ratio. In other aspects, a vehicle chassis can be designed to incorporate a compressed fuel reservoir as a structural part of the chassis. Methods, system, and articles of manufacture relating to these features are described.

### CROSS-REFERENCE TO RELATED APPLICATIONS

The current application is claims priority under 35 U.S.C. §119(e) to U.S. provisional patent application Ser. No. 61/391,487, filed on Oct. 8, 2010 and entitled “Direct Injection Techniques and Tank Architectures for Internal Combustion Engines Using Pressurized Fuels,” under 35 U.S.C. §119(e) to U.S. provisional patent application Ser. No. 61/501,654 filed on Jun. 27, 2011 and entitled “High Efficiency Internal Combustion Engine,” and under 35 U.S.C. §120 to Patent Cooperation Treaty Application No. PCT/US2011/055501 filed on Oct. 8, 2011 and entitled “Use of Pressurized Fuels in an Internal Combustion Engine.” The disclosure of each application listed in this paragraph is incorporated by reference herein in its entirety.

### TECHNICAL FIELD

The subject matter described herein relates to internal combustion engines and the operation thereof using one or more pressurized materials (e.g. gases) as fuel.

### BACKGROUND

Pressurized fuels, such as for example compressed natural gas (CNG), liquefied petroleum gas (LPG), hydrogen (H₂), or the like in a spark ignited engine are becoming a more common and widely available alternative to gasoline and diesel fuel. However, widespread use of these pressurized fuels has been hampered by several factors.

### SUMMARY

In one aspect, a method includes delivering an amount of inlet air to a combustion volume of an internal combustion engine via an air inlet port, controlling delivery of an amount of a fuel from a compressed fuel reservoir to the combustion volume via a pressurized fuel inlet port positioned to deliver the amount of the fuel directly into the combustion volume separately from the air inlet port, and igniting the air-fuel mixture. The amount of the fuel is controlled relative to the amount of the inlet air to create an air-fuel mixture having a target air/fuel ratio within the combustion volume.

In an interrelated aspect, a method includes directly injecting, via a pressurized fuel inlet port, a compressed fuel in a predetermined amount to a combustion volume of an internal combustion engine from a compressed fuel reservoir, monitoring a pressure within the compressed fuel reservoir, altering a timing of the direct injection of the compressed fuel based at least in part on the monitored pressure.

In another interrelated aspect, a system includes an air inlet port to deliver an amount of inlet air to a combustion volume of an internal combustion engine, a pressurized fuel inlet port positioned to deliver an amount of a fuel from a compressed fuel reservoir directly into the combustion volume separately from the air inlet port, and an ignition source to ignite the air-fuel mixture. The pressurized fuel inlet port is operable to control the amount of the fuel relative to the amount of the inlet air to create an air-fuel mixture having an air/fuel ratio within the combustion volume.

In yet another interrelated aspect, a system includes a compressed fuel reservoir for storing a pressurized fuel, at least one lug that connects the compressed fuel reservoir to one or more components of a motor vehicle such that the compressed fuel reservoir is an integrated structural member of a chassis of the motor vehicle, an internal combustion engine connected to one or more of the at least one lug, and a pressurized fuel supply line connecting the compressed fuel reservoir to a pressurized fuel inlet port of the internal combustion engine. The internal combustion engine is configured to operate using the pressurized fuel.

In some variations one or more of the following features can optionally be included in any feasible combination. The air inlet port can optionally be closed prior to controlling delivery of the amount of the fuel to the combustion volume such that delivery of the amount of the fuel does not displace air from the combustion volume. The controlling of the delivery can optionally further include determining a current pressure in the compressed fuel reservoir, calculating, based at least in part on the pressure, a period of time to open the pressurized fuel inlet port to provide the amount of fuel to create the target air-fuel mixture having the air/fuel ratio, and opening the pressurized fuel inlet port for the period of time to deliver the amount of fuel to the combustion volume at the current pressure in the compressed fuel reservoir. The determining can optionally include receiving input from a sensor, which can optionally include a pressure sensor associated with the compressed fuel reservoir. Alternatively or in addition, an actual air/fuel ratio in exhaust gases exhausted from the combustion volume of the internal combustion engine during at least one first engine cycle can be determined. The determining can optionally include using an oxygen sensor positioned to detect an oxygen concentration in the exhaust gases, comparing the actual air/fuel ratio to the target air/fuel ratio, and adjusting the injection duration for a subsequent engine cycle according to the comparing to more closely provide the target air/fuel ratio during the subsequent engine cycle. The pressurized fuel can optionally include at least one of compressed natural gas (CNG), liquefied petroleum gas (LPG), and hydrogen (H₂).

Monitoring of the pressure within the compressed fuel reservoir can optionally include receiving an output from a sensor and determining the pressure in the compressed fuel reservoir based on the output. Altering of the timing of the direct injection of the compressed fuel can optionally include calculating, based on the monitored pressure, a period of time to open the pressurized fuel inlet port to provide the predetermined amount of fuel. A method can optionally further include delivering air to the combustion volume via an air inlet port that is separate from the pressurized fuel inlet port. The predetermined amount of fuel can create an air-fuel mixture having a specified air/fuel ratio in the combustion volume. The ignition source can optionally include a spark plug.

A system can optionally include a controller (e.g. a computer system in some implementations) that performs one or more operations discussed above. Systems and methods consistent with this approach are described as well as articles that comprise a tangibly embodied machine-readable medium operable to cause one or more machines (e.g., computers, etc.) to result in one or more of the operations described herein. Similarly, computer systems are also described that may include a processor and a memory coupled to the processor. The memory may include one or more programs that cause the processor to perform one or more of the operations described herein.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a diagram illustrating aspects of an engine showing features consistent with implementations of the current subject matter;

FIG. 2 is a process flow diagram illustrating features of a method having one or more features consistent with implementations of the current subject matter;

FIG. 3 is a process flow diagram illustrating additional features of a method having one or more features consistent with implementations of the current subject matter;

FIG. 4 is a diagram illustrating aspects of another engine showing features consistent with implementations of the current subject matter;

FIG. 5 is a diagram illustrating aspects of another engine showing features consistent with implementations of the current subject matter;

FIG. 6 is a diagram illustrating features of a pressurized fuel reservoir architecture consistent with implementations of the current subject matter; and

FIG. 7 is a diagram illustrating features of another pressurized fuel reservoir architecture consistent with implementations of the current subject matter.

When practical, similar reference numbers denote similar structures, features, or elements.

### DETAILED DESCRIPTION

Use of a conventional fuel delivery system (e.g. one designed for a liquid fuel such as gasoline, diesel fuel, etc.) with pressurized gaseous fuels can result in a loss of power at a comparable ratio of air to fuel. One potential cause for this loss of power can be the standard practice of mixing the fuel (for example) with the air in the intake manifold of the internal combustion engine prior to its delivery to the combustion chamber of the engine. In a generic and non-limiting example, at least by a cylinder wall, one or more piston heads, and optionally a cylinder head can define the combustion volume. Because the fuel is mixed as a gas, at a constant intake pressure, the gas necessarily displaces an amount of intake air equal to the fuel volume added. The gaseous fuel can in some examples displace about 10% or more of the intake air. As such, for a given ratio of air to fuel, the maximum airflow and hence the maximum power of the engine can be limited by the expansion of the compressed fuel.

In a motor vehicle designed to operate using a pressurized fuel is typically stored at a high pressure, for example in a pressurized fuel container or reservoir or the like, so that a sufficient amount of the fuel can be conveniently transported. In a fuel delivery system in which inlet air and the fuel are mixed in a conventional intake manifold, a regulator can be required to reduce the pressure of the pressurized fuel to near ambient. This feature can also add to the cost of implementing pressurized fuels in a vehicle.

To address these and potentially other issues with currently available solutions, one or more implementations of the current subject matter provide methods, systems, articles or manufacture, and the like that can, among other possible advantages, provide for direct injection of a pressurized fuel to the combustion chamber so that expansion of the pressurized fuel in an intake manifold of the engine does not displace air and thereby reduce the total air flow through the engine. The storage pressure for CNG and other pressurized fuels can be similar to the pressures now used for gasoline direct injection. According to implementations of the current subject matter, direct injection technology can be applied to pressurized fuels. In some implementations, a pressure regulator can be eliminated, for example in favor of a pressure sensor in the pressurized fuel reservoir such that the duration of the delivery of fuel directly to the combustion can be varied in accordance with the supply pressure of the pressurized fuel reservoir to provide consistent engine performance despite changes in the supply pressure as fuel is consumed.

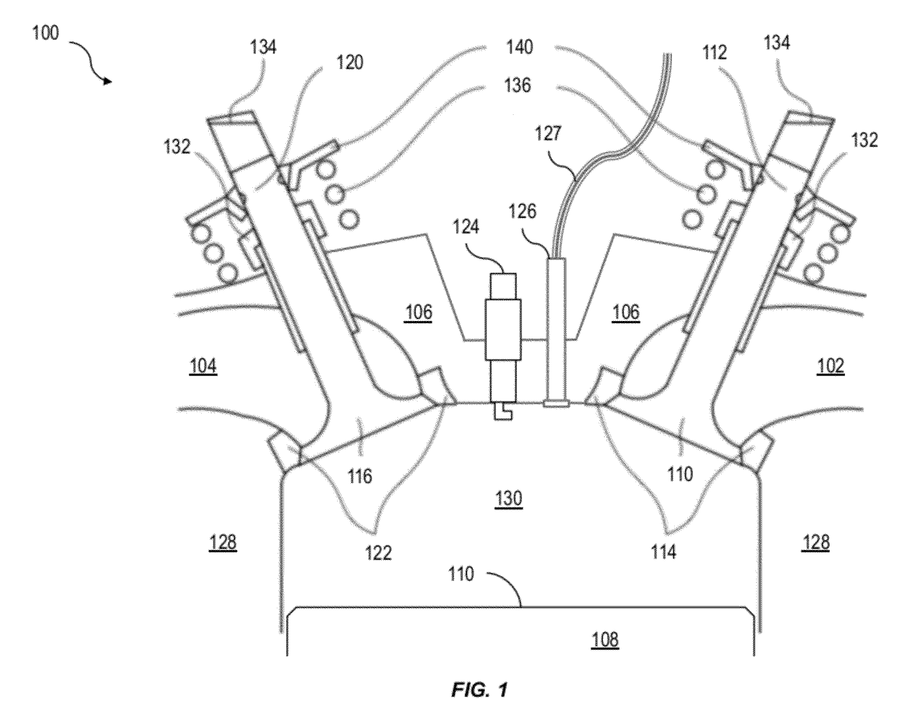

FIG. 1 shows an example of a part of an engine 100 having features consistent with one or more implementations of the current subject matter. An air inlet port 102 and an exhaust port 104 are positioned in or adjacent to a cylinder head 106 of an engine having each of one or more pistons 108 in its own cylinder. Each piston has a piston crown 110. Airflow through the air inlet port 102 shown in FIG. 1 is controlled by a first poppet valve assembly including an air inlet valve head 110, an air inlet valve stem 112, and an air inlet valve seat 114, while flow though the exhaust port 104 is controlled by a second poppet valve assembly including an exhaust valve head 116, an exhaust valve stem 120, and an exhaust valve seat 122, respectively. In the configuration shown in FIG. 1, a spark plug 124 and a pressurized fuel inlet port 126 are shown passing through the cylinder head 106. The pressurized fuel port 126 can be connected, for example via a fuel delivery tube 127, to a pressurized fuel reservoir (not shown). Other positions for the spark plug 124 or other ignition source and for the pressurized fuel inlet port 126 (e.g. along the periphery of the cylinder head 106, in the cylinder walls 128, etc.) are also within the scope of the current subject matter.

The piston crown 108, the cylinder walls 128, and the cylinder head 106 define a combustion volume 130 into which the compressed fuel is delivered via the pressurized fuel port 126 after the air inlet port 102 is closed by the inlet valve head 110 being urged against the inlet valve seat 114 More than one spark plug 124 or other ignition source can also be used, as can more than one pressurized fuel inlet port 126. Each valve assembly can include a valve stem seal 130, a rocker arm or valve lift arm 134 connected to one or more cams to activate (e.g. open) the valve, and a coil or spring 136 to urge the valve into a closed position against the valve seat 114 or 122. A spring retainer 140 retains the spring 136.

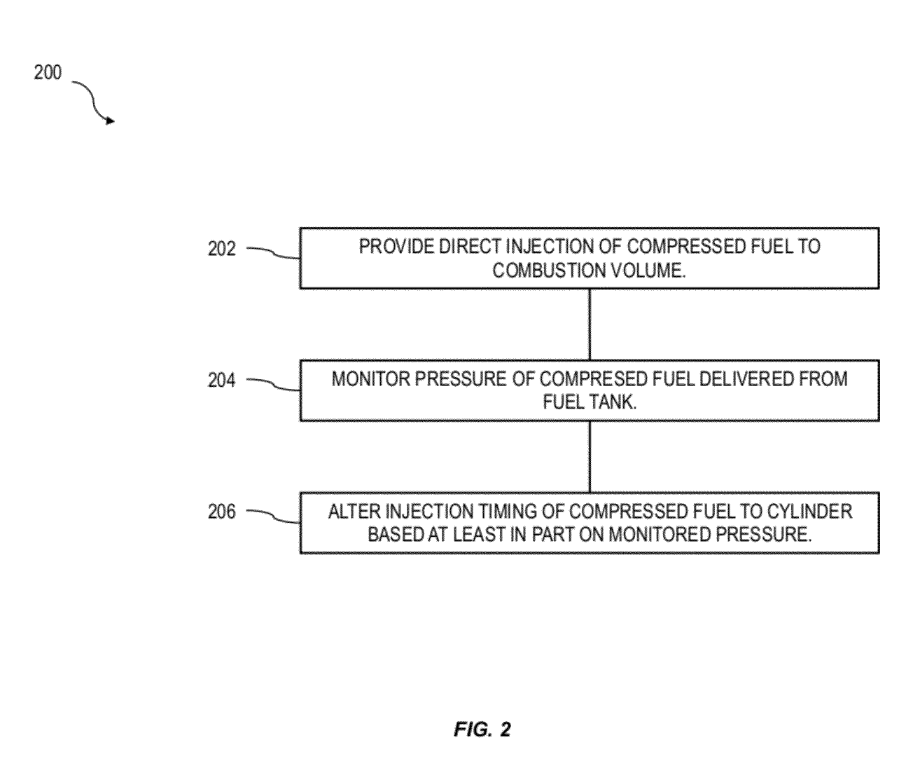

FIG. 2 illustrates features of a method consistent with the current subject matter. At 202, compressed fuel can be direly injected, for example via a pressurized fuel port 126, into a combustion volume 130 within a cylinder of an internal combustion engine. The direct injection can occur after an air inlet valve has been closed such that the addition of the compressed fuel does not displace the delivered air form the combustion volume 130. Because the pressure in the tank generally continuously changes as fuel is withdrawn, an oxygen sensor can be placed in the exhaust stream or a pressure sensor can be included within or otherwise incorporated with the pressurized fuel reservoir. At 204, the pressure of the compressed fuel delivered from a fuel tank or other compressed fuel reservoir can be monitored, for example directly via a pressure sensor, indirectly via an oxygen sensor, or using other means.

An injection timing, in other words, a period of time during which the pressurized fuel is allowed to pass through the pressurized fuel port can be altered at 206 from engine cycle to engine cycle according at least to the monitored pressure and the current throttle demands of the engine. In the case of an oxygen sensor, an actual air/fuel ratio in one or more first engine cycles can be determined using the oxygen sensor positioned to detect an oxygen concentration in the in the exhaust gases of one or more engine cycles and compared to the requested air/fuel ratio. The injection duration can be adjusted to ensure that the target air/fuel ratio is delivered in a subsequent engine cycle. Since the pressure change rate of the tank can be generally slow compared to the time constant of the fueling system of the engine, simple feed forward information can be satisfactory. An oxygen sensor generally observes a trend over a number of cycles (e.g. approximately 10 to 100 or more). This trend measurement can be used to modify the pressurized fuel injection time over one or more subsequent engine cycles. In some variations, an offset to the air/fuel map already programmed into a fuel injection controller can be used to correct for diminishing tank pressures.

By injecting the fuel via the pressurized fuel port directly into the combustion volume after the air inlet valve is closed, the volume of the fuel does not displace any of the incoming air, so the total intake air flow rate can be maximized. Additionally, the injection of the fuel into the closed combustion volume can increase the density of the fuel charge in the combustion volume, thereby providing an effective supercharger bonus of approximately 10% or more under some conditions. This supercharging effect can be attained without the need for extra equipment. If the fuel is injected early in the compression cycle, there can be adequate time for mixing of the two gases (air and fuel) to make a homogeneous mixture. If desired, an additional injection of the compressed fuel via the pressurized fuel port can be done late in the cycle near the spark plug to allow for a stratified charge. Rich or stoichiometric conditions can be provided near the spark for easy ignition with lean conditions occurring farther from the spark to promote higher fuel efficiency.

A system or method consistent with the current subject matter can use the high pressure gas from the storage cylinder directly. Flexible high pressure plumbing 127 can be used to connect the vibrating engine to the stationary tank. An orifice can be installed in the fuel supply line such that a computer or other programmable device implementing the variable direct injection timing can compare the pressure drop across it to the flow require for injection. In this manner, the computer can preset its fuel map (without needing the oxygen sensor) for the incoming pressure in addition to sensing whether there is a leak between the tank and the engine. Safeties can be included to shut the tank if such a leak is detected.

The injection timing can become quite long when the tank is nearing empty. As continuing to inject fuel after ignition may not be desirable, this constraint can set an upper limit on the period of fuel delivery via the pressurized fuel port 126. If more time is needed to inject, the computer can be programmed to start the injection even before the air inlet port 102 is closed. This approach can cause a slight loss of power, but since most of the fuel is still injected after the air inlet port 102 is closed, the loss of power would be minimal.

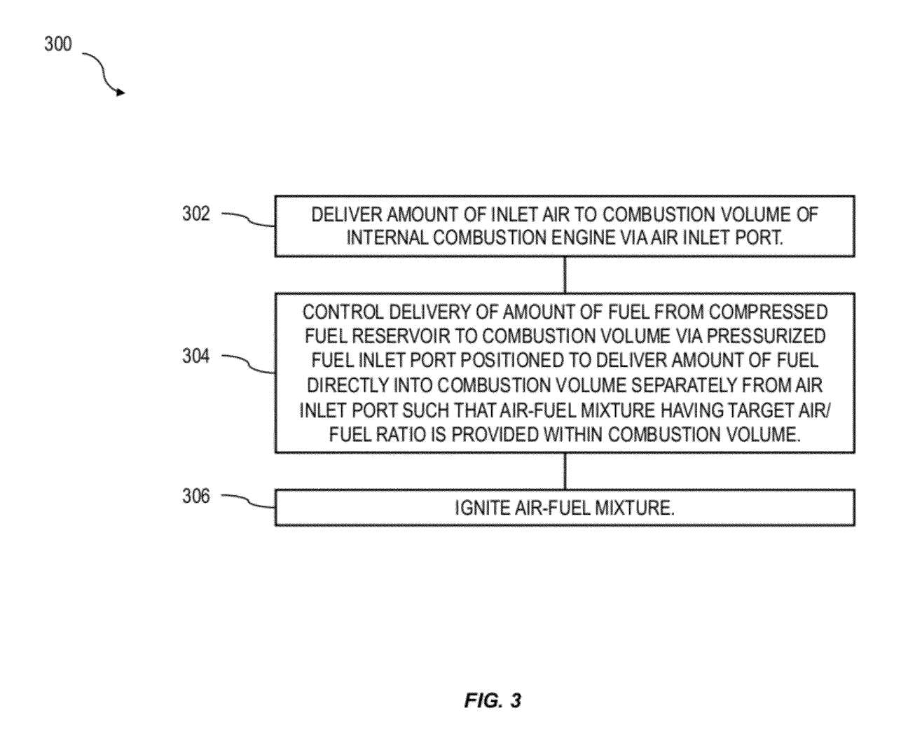

FIG. 3 illustrates additional features of a method consistent with the current subject matter. At 302, an amount of inlet air is delivered to a combustion volume 130 of an internal combustion engine via an air inlet port 102. Delivery of an amount of a fuel from a compressed fuel reservoir to the combustion volume is controlled at 304 via a pressurized fuel inlet port positioned to the deliver the amount of the fuel directly into the combustion volume separately from the air inlet port. The amount of the fuel is controlled relative to the amount of the inlet air to create an air-fuel mixture within the combustion volume having an air/fuel ratio. At 406, the air-fuel mixture is ignited.

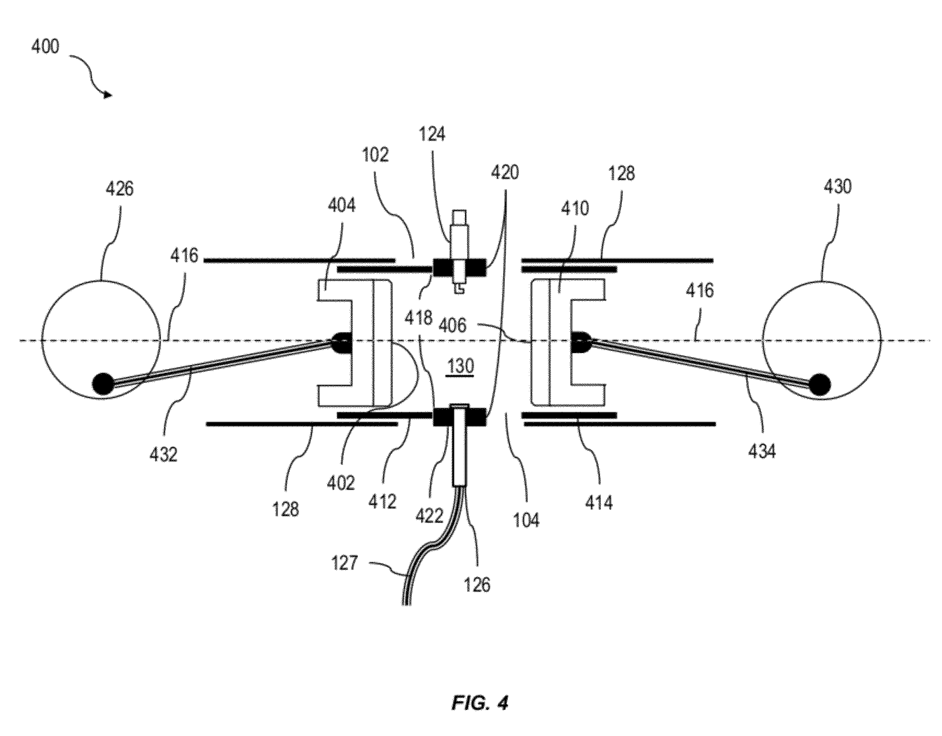

FIG. 4 shows another example of a part of an engine 400 having features consistent with one or more implementations of the current subject matter. In this engine 400, an opposed piston configuration is used, in which two pistons share a common cylinder. A first piston crown 402 of a first piston 404, a second piston crown 406 of a second piston 410, and cylinder walls 128 generally at least partially define a combustion volume 130 into which air is provided via one or more air inlet ports 102 and from which burned combustion gases are exhausted via one or more exhaust ports 104. One approach to opposed piston engines involves the use of sleeve valves 412, 414 to control flow through the one or more air inlet ports 102 and the one or more exhaust ports 104. The sleeve valves 412, 414 can move at least in a direction parallel to an axis of translation 416 of the pistons 404, 410 such that in a closed position they are urged into contact with valve seats 418, 420 that can be part of a center ring or other connecting piece 422 joining two parts of an engine block that each define part of the cylinder walls 128. The center ring or other connecting piece 132 can also provide a pass-through for one or more spark plugs 124 and for a pressurized fuel port 126, which can be connected, for example via a fuel delivery tube 127, to a pressurized fuel reservoir (not shown). Each piston 404, 410 can be connected to a respective crankshaft 426, 430 by a respective connecting rod 432, 434.

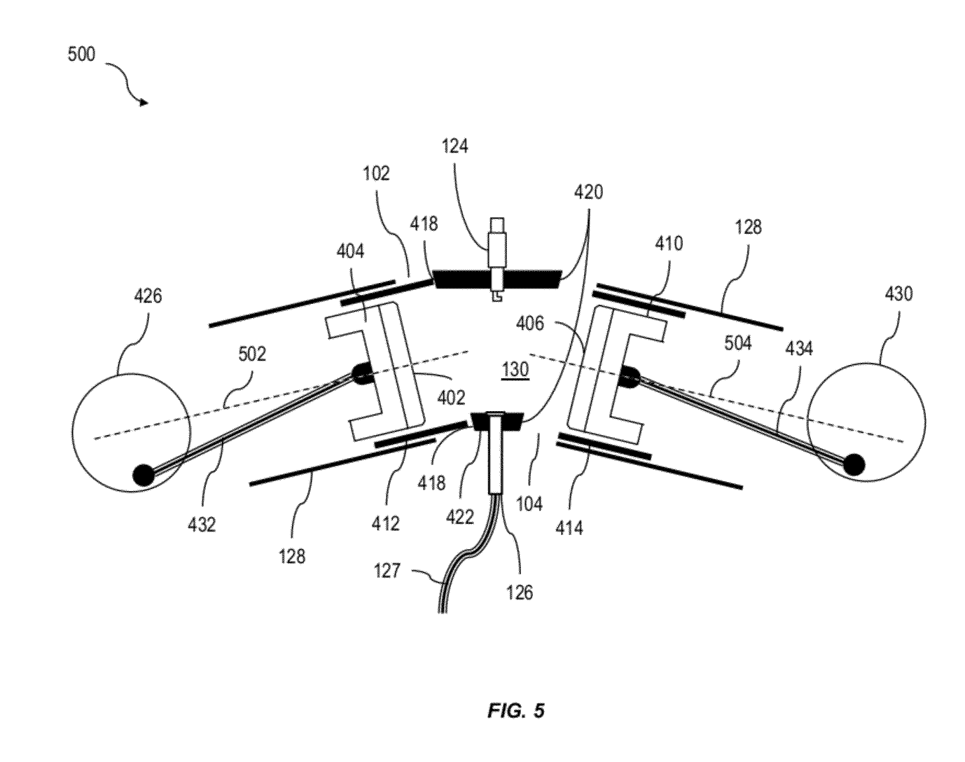

FIG. 5 shows another configuration of a part of an engine 400 having features consistent with one or more implementations of the current subject matter. The features of the engine 500 are similar to those of the engine 400 illustrated in FIG. 4 with the exception of the axis of translation of the pistons 404, 410. Unlike in FIG. 4, there is not a common axis of translation 416. Instead, the first piston 404 has a first axis of translation 502, and the second piston 410 has a second axis of translation 504. The two axes of translation 502, 504 can be arranged at an angle to one another such that the connecting piece 422 can be larger on one side of the engine block than it is on an opposite side of the engine block. If, as shown in FIG. 5, the two axes of translation 502, 504 form an inverted “V” shape, the connecting piece 422 can have a larger area at the top of the engine than it does at the bottom. This larger area can provide additional clearance to position one or more spark plugs 124 such that the ignition tip of the spark plug 124 is not as close to either piston crown 402, 406 at the top dead center position of the two pistons 404, 410. A pressurized fuel port 126, which can be connected, for example via a fuel delivery tube 127, to a pressurized fuel reservoir (not shown), can also pass through the connecting piece 422 at a convenient location. The location of the pressurized fuel port 126 can optionally be adjacent to the spark plug 124 or, as shown in FIG. 5, at some other location on the connecting piece 422.

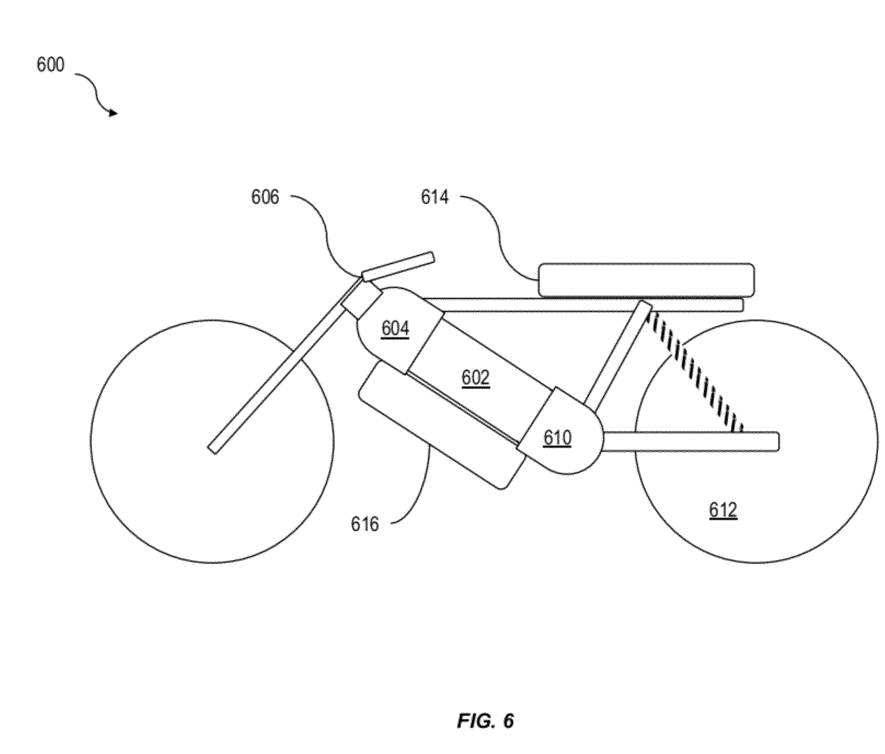

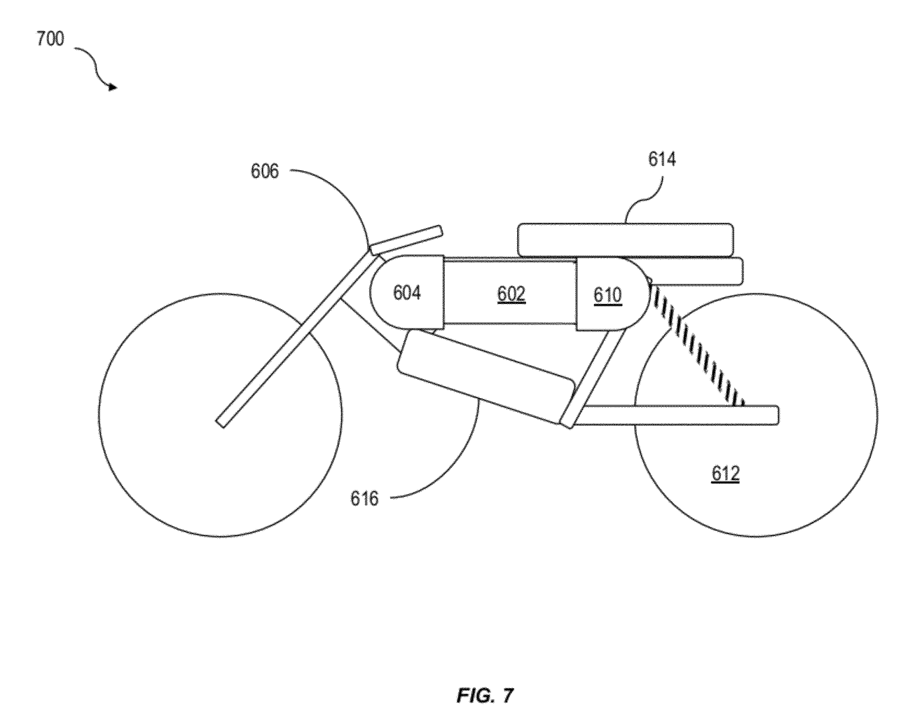

In another implementation, variations of which are illustrated in FIG. 6 and FIG. 7, a compressed fuel reservoir or tank, for example for CNG, LPG, hydrogen, or the like, can be incorporated as a frame member of a vehicle chassis. High pressure tanks generally package poorly and can add significant weight to a vehicle. However, by incorporating the fuel tank as a stressed member of a vehicle chassis as described herein, significant advantages can be realized. The extra strength needed to support frame loads are generally small compared to the loads from the gas pressure, particularly in the case of CNG tanks. As such, extra material needed to support the frame loads can be minimal.

A motorcycle or other vehicle can include one or more lugs that can be attached at various places on a compressed fuel reservoir to transfer a load from a vehicle engine into the compressed fuel reservoir over a reasonable area. The lugs can be attached to the compressed fuel reservoir such that the attachment points do not alter the strength characteristics of the material from which the compressed fuel reservoir is constructed. In one example, the lugs can be compressed fuel reservoir brackets that are brazed to a steel compressed fuel reservoir or alternatively attached thereto using an adhesive, such as for example an epoxy resin. The adhesive can advantageously be of a lower modulus than the material of the compressed fuel reservoir to provide a better distribution of loads.

In an example illustrated in FIG. 6, a compressed fuel reservoir 602 can be integrated into the frame structure of a motorcycle 600. One lug 604 can encircle one end of the compressed fuel reservoir 602 and include structure needed to attach the steering head 606 of the motorcycle while a second lug 610 can be attached to the other end of the compressed fuel reservoir 602 allowing for a suspension system for the rear wheel 612 to be attached. A seat 614, instruments (not shown in FIG. 6), and other ancillary structures can be attached to either or both lugs 604, 610. The lugs 604, 610 can include at least some access to the compressed fuel reservoir 602 to allow both filling and draining of the fuel.

An internal combustion engine 616 can be attached to either a third lug or to one or, as shown in FIG. 6, both of the existing lugs 604, 610 using conventional soft engine mounts. In this configuration, a regulator can be included, for example attached to one of the lugs 604, 610, to reduce the pressure delivered from the compressed fuel reservoir 602. An at least partially fairly flexible fuel line (not shown) can connect the regulator to the engine. Alternatively, a specially designed high pressure line can be connected directly from the compressed fuel reservoir 602 to the engine 616. This line can be engineered to insure that stress levels and fatigue do not cause cracks to form over the life of the vehicle 600. Approaches to protect against stress damage and leaks can include, but are not limited to, coiled sections of tubing that allow generous movement without inducing much stress. The coiled section can be attached to or covered with an elastomer that can provide some damping to minimize or eliminate the effects of resonant frequency vibrations.

In another example illustrated in FIG. 7, the engine 616 can be bolted directly to one of the lugs 604 so that the relative motion between the engine 616 and the tank is almost zero. In this manner, a much more rigid and potentially more robust connection can be made with the fuel line. Such an approach can be advantageous in an opposed piston engine or other engine configuration that has significant vibration levels throughout its operating range that are below acceptable levels for the operator or passengers. A rigid fuel line structure can be desirable where high pressure fuel needs to be delivered to the engine 616 directly.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

1. A method comprising:
delivering an amount of inlet air to a combustion volume of an internal combustion engine via an air inlet port;
controlling delivery of an amount of a fuel from a compressed fuel reservoir to the combustion volume via a pressurized fuel inlet port positioned to deliver the amount of the fuel directly into the combustion volume separately from the air inlet port, the amount of the fuel being controlled relative to the amount of the inlet air to create an air-fuel mixture having a target air/fuel ratio within the combustion volume; and
igniting the air-fuel mixture.

2. A method as in claim 1, further comprising: closing the air inlet port prior to controlling delivery of the amount of the fuel to the combustion volume such that delivery of the amount of the fuel does not displace air from the combustion volume.

3. A method as in claim 1, wherein the controlling delivery further comprises:
determining a current pressure in the compressed fuel reservoir;
calculating, based at least in part on the pressure, a period of time to open the pressurized fuel inlet port to provide the amount of fuel to create the target air-fuel mixture having the air/fuel ratio; and
opening the pressurized fuel inlet port for the period of time to deliver the amount of fuel to the combustion volume appropriate for the current pressure in the compressed fuel reservoir.

4. A method as in claim 3, wherein the determining comprises receiving input from a sensor.

5. A method as in claim 4, wherein the sensor comprises a pressure sensor associated with the compressed fuel reservoir.

6. A method as in claim 1, further comprising:
determining an actual air/fuel ratio in exhaust gases exhausted from the combustion volume of the internal combustion engine during at least a first engine cycle, the determining comprising using an oxygen sensor positioned to detect an oxygen concentration in the exhaust gases;
comparing the actual air/fuel ratio to the target air/fuel ratio; and
adjusting the injection duration for a subsequent engine cycle according to the comparing to more closely provide the target air/fuel ratio during the subsequent engine cycle.

7. A method as in claim 1, wherein the pressurized fuel comprises at least one of compressed natural gas (CNG), liquefied petroleum gas (LPG), and hydrogen (H₂).

8. A method comprising:
directly injecting, via a pressurized fuel inlet port, a compressed fuel in a predetermined amount to a combustion volume of an internal combustion engine from a compressed fuel reservoir;
monitoring a pressure within the compressed fuel reservoir; and altering a timing of the direct injection of the compressed fuel based at least in part on the monitored pressure.

9. A method as in claim 8, wherein the monitoring comprises receiving an output from a sensor and determining the pressure in the compressed fuel reservoir based on the output.

10. A method as in claim 9, wherein the altering comprises calculating, based on the monitored pressure, a period of time to open the pressurized fuel inlet port to provide the predetermined amount of fuel.

11. A method as in claim 10, further comprising delivering air to the combustion volume via an air inlet port that is separate from the pressurized fuel inlet port and wherein the predetermined amount of fuel creates an air-fuel mixture in the combustion volume, the air-fuel mixture having a specified air/fuel ratio.

12. A system comprising:
an air inlet port to deliver an amount of inlet air to a combustion volume of an internal combustion engine;
a pressurized fuel inlet port positioned to deliver an amount of a fuel from a compressed fuel reservoir directly into the combustion volume separately from the air inlet port, the pressurized fuel inlet port being operable to control the amount of the fuel relative to the amount of the inlet air to create an air-fuel mixture having an air/fuel ratio within the combustion volume; and
an ignition source to ignite the air-fuel mixture.

13. A system as in claim 12, further comprising a controller that performs operations comprising:
controlling delivery of the amount of the fuel to the combustion volume after the closing of the inlet port such that delivery of the amount of the fuel does not displace air from the combustion volume.

14. A system as in claim 12, further comprising a controller that performs operations comprising:
determining a current pressure in the compressed fuel reservoir;
calculating, based at least in part on the pressure, a period of time to open the pressurized fuel inlet port to provide the amount of fuel to create the air-fuel mixture having the air/fuel ratio; and
opening the pressurized fuel inlet port for the period of time to deliver the amount of fuel to the combustion volume at the current pressure.

15. A system as in claim 14, further comprising a sensor that provides a signal to the controller, and wherein the determining comprises receiving the signal.

16. A system as in claim 15, wherein the sensor comprises a pressure sensor associated with the compressed fuel reservoir.

17. A system as in claim 12, further comprising a controller that performs operations comprising:
determining an actual air/fuel ratio in exhaust gases exhausted from the combustion volume of the internal combustion engine during at least a first engine cycle, the determining comprising using an oxygen sensor positioned to detect an oxygen concentration in the exhaust gases;
comparing the actual air/fuel ratio to the target air/fuel ratio; and
adjusting the injection duration for a subsequent engine cycle according to the comparing to more closely provide the target air/fuel ratio during the subsequent engine cycle.

18. A system as in claim 17, wherein the controller comprises at least one programmable processor and a machine-readable medium storing instructions that the programmable processor executes.

19. A system as in claim 12, wherein the ignition source comprises a spark plug.

20. A system as in claim 12, further comprising:
the compressed fuel reservoir for storing the fuel;
at least one lug that connects the compressed fuel reservoir to one or more components of a motor vehicle such that the compressed fuel reservoir is an integrated structural member of a chassis of the motor vehicle;
the internal combustion engine connected to one or more of the at least one lug, the internal combustion engine being configured to operate using the fuel; and
the pressurized fuel supply line connecting the compressed fuel reservoir to a pressurized fuel inlet port of the internal combustion engine.
